(19) United States
(12) Patent Application Publication
(10) Pub. No.: US 2026/0018090 A1
(43) Pub. Date: Jan. 15, 2026

(54) SECURE IMAGE DISPLAY BASED ON VANTAGE POINT OF VIEWER

(71) Applicant: Numéraire Financial, Inc., Chicago, IL (US)

(72) Inventors: Alexander LIPTON, Abu Dhabi (AE); Marsha LIPTON, Abu Dhabi (AE); Thomas P. HARDJONO, Winchester, MA (US)

(21) Appl. No.: 18/771,939

(22) Filed: Jul. 12, 2024

(51) Int. Cl. G09G 3/00; G06F 21/32

(52) U.S. Cl. CPC G09G 3/003; G06F 21/32; G09G 2354/00; G09G 2358/00

(57) ABSTRACT

A predictive display system that enables display of different image sets depending on the vantage point of the viewer. The image sets can range from slight variations of the image (e.g., a change in color or a change in viewing angle) to display of an image of a different object. The image sets may be pre-computed or computed on-the-fly based on vantage point data of the viewer in a current session and the viewer’s historical data from previous sessions. Predictive algorithms may be used to determine the viewer’s next likely vantage point(s) in the next milliseconds to seconds.

### BACKGROUND

Some digital artworks and other types of digital assets are restricted in number and/or in circulation. Creators and owners of digital assets may desire to trade these assets globally, while at the same time requiring counterfeit detection and prevention mechanisms to be employed. In many instances, the owners of high-value physical assets (e.g., rare artwork) are prevented from using or enjoying the asset because of the extreme value of the asset. In these and other scenarios, a digital scan of the asset can be created. For example, the original physical asset might be a painting, and a digital asset corresponding to the painting can be a high-resolution scan of the painting. The digital asset can then be displayed on a display screen.

Metaverses provide alternative digital universes in which users can participate. Many of these metaverses enable users to create an avatar representing the user (e.g., a graphical image, or a three-dimensional model, etc.) while the user engages with the digital universe and with other users.

### BRIEF DESCRIPTION OF DRAWINGS

Various examples in accordance with the present disclosure will be described with reference to the drawings, in which:

FIG. 1 is a schematic diagram illustrating components of a predictive display system (PDS), and a viewer viewing the PDS from different vantage points, according to some examples;

FIG. 2 is a schematic diagram illustrating precomputation of a set of frames to be displayed to a viewer based on the viewer’s vantage point according to some examples;

FIG. 3 is a schematic diagram illustrating display of different 3-D holographic images of objects depending on the vantage point of the viewer according to some examples;

FIG. 4 is a schematic diagram illustrating generation of different layered image sets based on a seed image and the vantage point of the viewer according to some examples;

FIG. 5 is a schematic diagram illustrating a method for creating personalized digital art for a specific viewer based on the viewer’s vantage point history and a selection of a seed image specifically for that viewer according to some examples;

FIGS. 6 and 7 are schematic diagrams illustrating two users using respective PDSs to interact in a metaverse network via avatars according to some examples;

FIG. 8 is a schematic diagram illustrating three users using respective PDSs to interact in a metaverse network via private avatars according to some examples;

FIGS. 9 and 10 are schematic diagrams illustrating a confidential virtual venue (CVV), where users can interact in a private 3-D virtual reality environment, as a separate computing environment from a main metaverse environment according to some examples;

FIG. 11 is a schematic diagram illustrating a CVV node as a computing stack distinct from the main metaverse network according to some examples;

FIG. 12 is a schematic diagram illustrating a confidential art display system for viewing private art according to some examples;

FIG. 13 is a process flow diagram illustrating negotiation and derivation steps according to some examples; and

FIG. 14 is a block diagram illustrating an example computer system that may be used in some embodiments.

### DETAILED DESCRIPTION

The present disclosure relates to secure image display based on the vantage point of a viewer and, in some embodiments, based on both the vantage point of the viewer and authentication (e.g., bio-authentication) of the viewer. Currently, when an image is displayed on a screen the image appears the same to all viewers regardless of the viewers’s respective vantage points. A viewer positioned directly in front of the center of the screen thus sees the same image as another viewer positioned toward the right side of the screen or another viewer positioned toward the left side of the screen. This sameness across vantage points unfortunately makes the image appear flat and two-dimensional. It also makes it possible for unauthorized viewers to see images and/or information displayed on an authorized viewer’s screen, for example when such unauthorized viewers are present at the same time the authorized viewer is viewing the images and/or information on his or her personal device. To solve these technical problems, a predictive display system (PDS) according to some examples described herein predicts the viewer’s vantage point (e.g., body position, body posture, eye position, etc.) for a future time interval (e.g., the next few seconds), and displays different image(s) when the viewer views the display from the predicted vantage point(s), such that the image does not appear the same from all vantage points, and/or may only be viewable from a limited range of vantage points. In some embodiments, the PDS uses predictive artificial intelligence, and may be configured to show certain images when the user is viewing the display from specific vantage points. In some embodiments, these vantage point-dependent images may be encrypted in such a way that they are decipherable only when the user has been bio-authenticated and is in the designated possible set of vantage points. Example applications of the PDS include digital art (2-D and 3-D), metaverse interactions among users, and defense-related use cases.

Several example use cases are described below related to the display of images on the PDS that are dependent on either the authentication (e.g., bio-authentication) of the viewer or the viewer’s vantage point (e.g., the viewer’s physical position with respect to the PDS and/or the direction in which the viewer’s eyes are looking), or both the bio-authentication of the viewer and the viewer’s vantage point. For example, in some embodiments digital art image files may be stored in such a way that they can only be displayed after a bio-authentication of the viewer has been performed. In another example, in some embodiments a 3-D image of an artwork (e.g., sculpture) may be presented to the viewer such that different sides of the artwork are displayed depending on the vantage point of the viewer. In another example, in some embodiments a user in the physical world may be digitally represented as a 3-D avatar image (or set of images) in a metaverse space, such that when multiple users interact in a common metaverse space they are each represented as a 3-D avatar, and users see different images of each 3-D avatar based on each viewer’s vantage point in the physical world. In another example, in some embodiments digital files may be accessible only to certain leadership roles within a company (e.g., CxO-level only), and access to and/or display of these files may be constrained not only by the bio-authentication of the viewer (e.g., retina scan, fingerprint, facial scan) but also by the viewing device (e.g., a PDS in the CEO’s office). In another example, in some embodiments confidential digital files can be access-protected (e.g., encrypted) such that they are only accessible when an authorized user has been authenticated (e.g., bio-authenticated) by the PDS and the user is at an appropriate vantage point.

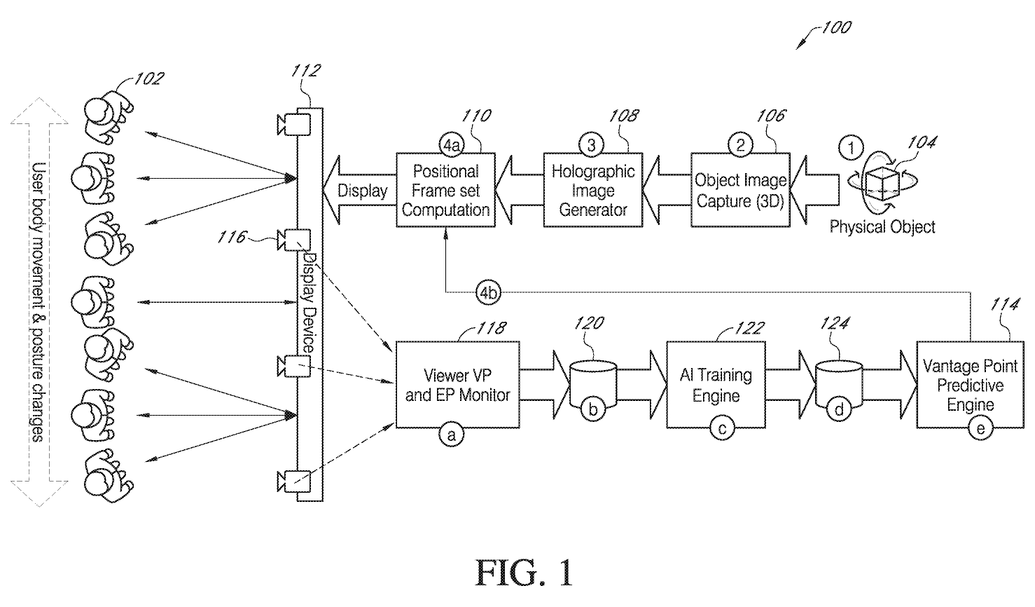

FIG. 1 illustrates components of a predictive display system (PDS) 100, and a viewer 102 viewing the PDS 100 from different vantage points, according to some examples. Components of the PDS 100 can be grouped into two categories, namely those involved in (1) image preparation and presentation, and (2) monitoring the viewer’s vantage point and predictive computations. The first set of components, which relate to preparation and presentation of the image to the viewer 102 that is dependent on the vantage point of the viewer 102, include the physical object 104 that will be represented as images on the PDS 100, an object image capture component 106, a holographic image generator 108, and a positional frame set computation component 110. In some embodiments, the object image capture component 106 may comprise a set of one or more cameras (not shown), such as multiple cameras positioned to capture images of the physical object 104 from different angles. In some embodiments, the set of one or more cameras may comprise a single camera, wherein the camera moves with respect to the physical object 104, or the physical object 104 moves with respect to the camera, to capture images of the physical object 104 from different angles. The images generated by the object image capture component 106 are received as input by the holographic image generator 108, which generates as output a 3-D image of the entire object imaged by the object image capture component 106. In some embodiments, the holographic image generator 108 includes a spatial light modulator (SLM) and software that maps the output of the SLM into frames (e.g., frame sets) that are shown on the display 112. The 3-D image created by the holographic image generator 108 is received as input by the positional frame set computation component 110, which pre-computes different sets of image frames, where each set of image frames represents the three-dimensional physical object 104 as it would appear from different vantage points. The sets of image frames output by the positional frame set computation component 110 are buffered and displayed by a display device 112 of the PDS 100 based on the vantage point of the viewer 102.

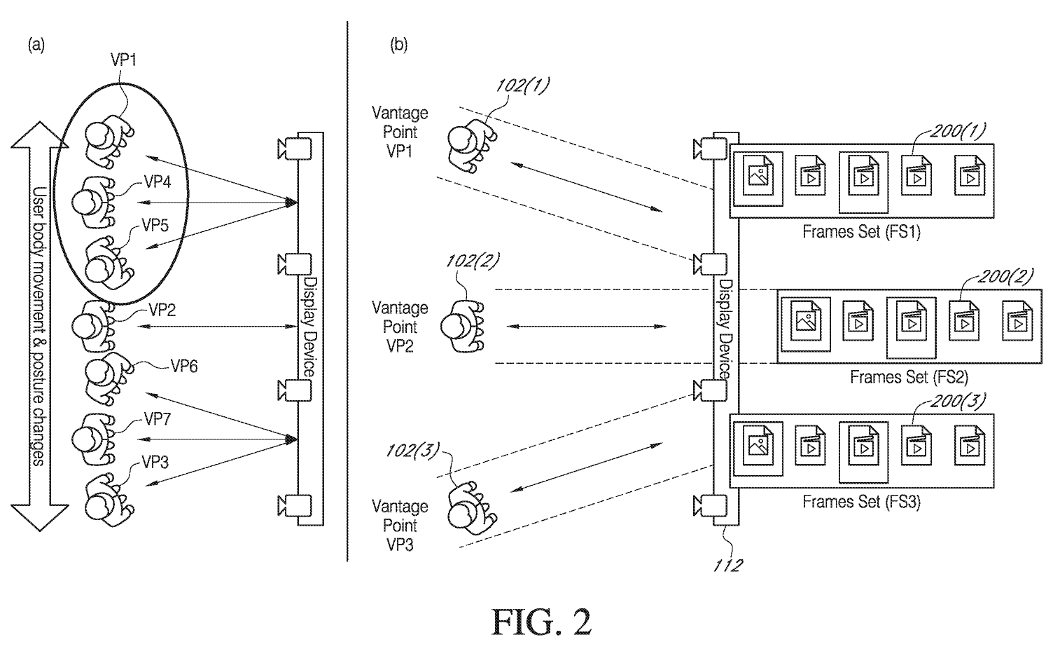

This process is illustrated in FIG. 2(b), in which a first frame set FS1 of the different sets of image frames 200(1) is selected and displayed on the display device 112 of the PDS 100 when it is determined that the viewer 102 is at a first vantage point VP1 that is toward a left side of the PDS 100, a second frame set FS2 of the different sets of image frames 200(2) is selected and displayed on the display device 112 of the PDS 100 when it is determined that the viewer 102 is at a second vantage point VP2 that is directly in front of a center of the PDS 100, and a third frame set FS3 of the different sets of image frames 200(3) is selected and displayed on the display device 112 of the PDS 100 when it is determined that the viewer 102 is at a third vantage point VP3 that is toward a right side of the PDS 100. The viewer 102(1) at the first vantage point VP1 thus sees an image on the PDS 100 based on the first frame set FS1, which represents how the three-dimensional physical object 104 would appear when viewed from the same vantage point as VP1. Similarly, the viewer 102(2) at the second vantage point VP2 sees an image on the PDS 100 based on the second frame set FS2, which represents how the three-dimensional physical object 104 would appear when viewed from the same vantage point as VP2, and the viewer 102(3) at the third vantage point VP3 sees an image on the PDS 100 based on the third frame set FS3, which represents how the three-dimensional physical object 104 would appear when viewed from the same vantage point as VP3. The selection of the frame set to be displayed on the display device 112 of the PDS 100 is based at least in part on parameters generated by a vantage point predictive engine (VPPE) 114 (FIG. 1), as discussed below.

While FIG. 2(b) shows the viewer 102 at three vantage points VP1, VP2, VP3, the positional frame set computation component 110 may pre-compute any number of sets of image frames, where each image frame set corresponds to a different vantage point. Thus, image frame sets may be pre-computed for any number of increments in vantage points (e.g., viewing angles). For example, in some embodiments the PDS 100 may be configured to display different sets of image frames for each increment of change in the viewer’s viewing angle. In some embodiments, the value of the increment may be 30 degrees, or 25 degrees, or 20 degrees, or 15 degrees, or 10 degrees, or 5 degrees, or 1 degree, or any other value. For example, FIG. 2(a) shows the viewer 102 at seven vantage points VP1, VP2, VP3, VP4, VP5, VP6, VP7.

As discussed above, components of the PDS 100 can be grouped into two categories, where the first set of components relates to preparation and presentation of the image to the viewer 102 that is dependent on the vantage point of the viewer 102. The second set of components relates to the predictive computation regarding the next vantage point of the viewer 102 based on the viewer’s behavior as tracked by user-facing sensors 116 that record the viewer’s physical characteristics. With reference to FIG. 1, these components include a viewer vantage point and eye position monitor 118, a viewer data store 120, an AI (artificial intelligence) training engine 122, a predictive models database 124, and the VPPE 114. In some embodiments, the viewer vantage point and eye position monitor 118 includes the sensors 116, such as cameras, body heat sensors, eyeball retina sensors (e.g., sensors configured to track eyeball movement and/or retina patterns), etc., that track and/or record the viewer’s vantage point as the viewer 102 moves about in front of the PDS 100. In some embodiments, the viewer’s vantage point may depend upon one or more of body position, body orientation, body posture, eye position, or eye orientation (the direction in which the viewer’s eyes are looking), and the viewer vantage point and eye position monitor 118 may include hardware and/or software that enables detection and/or tracking of one or more of these features. In some embodiments, the viewer vantage point and eye position monitor 118 may further include a bio-authentication module (not shown) that authenticates the viewer 102 based on physical features of the viewer 102. These physical features may include, without limitation, one or more of fingerprints, palmprints, facial features, retinal patterns, and/or any other physical features capable of being used to identify and/or authenticate the viewer 102, and the bio-authentication module may include hardware and/or software that enables identification and/or authentication of the viewer 102 based on one or more of these physical features.

The data collected by the sensors 116 of the viewer vantage point and eye position monitor 118 is output and stored in the viewer data store 120. The viewer data store 120 may store viewer-specific data for multiple viewers, where the viewer-specific data for each viewer is segregated (e.g., stored separately) from the data for other viewers. The viewer-specific data is used as input for the AI training engine 122, which outputs one or more predictive models and parameters for the viewers. For example, in some embodiments multiple viewer-specific predictive models and corresponding viewer-specific parameters may be created for each viewer 102. In other embodiments, one or more predictive models and corresponding parameters may be created for a population of multiple viewers. In some embodiments, a predictive model may use historical data recorded from the sensors 116 for a particular viewer, and combine that data with historical data recorded from the sensors 116 for other viewers with similar physical characteristics (e.g., height and/or weight). In some embodiments, algorithms may look for repeating patterns of body posture changes that a particular viewer habitually makes, such as head movement and/or positioning (e.g., tilt), arm swing, gait, etc. In some embodiments, the parameters for the viewers may comprise physical characteristics, such as height and/or weight. The predictive models and corresponding parameters are stored in a predictive models database 124. The VPPE 114 uses the predictive models and parameters from the database 124 to compute likelihoods for next possible vantage points for the viewer 102. For a new viewer, in some embodiments, the VPPE 114 may use the historical data of other viewers of similar body size, height, weight, and/or other physical characteristics. Output of the VPPE 114 of one or more sets of possible vantage point parameters are then provided as input to the positional frame set computation component 110, which uses the input to compute the image frame sets FS1, FS2, FS3, etc. described above.

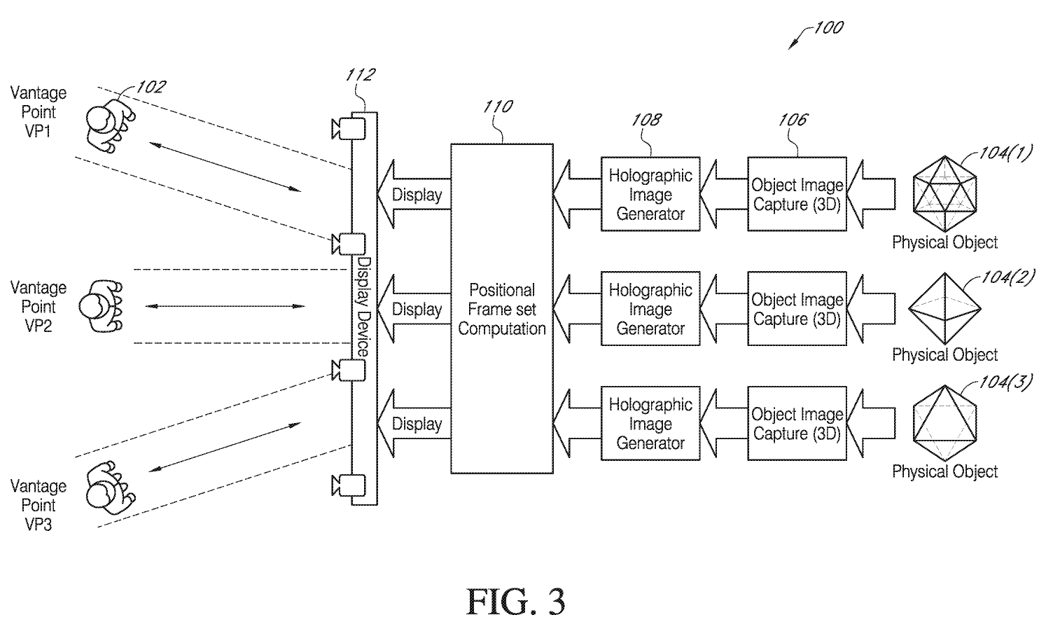

One advantageous feature of some embodiments of the PDS 100 is the ability to display different image frame sets depending on the vantage point of the viewer 102. For example, the image frame sets may range from slight variations of the object’s image (e.g., changes in color or changes in viewing angle based on the viewer’s vantage point) to displaying images of a different object based on the viewer’s vantage point. FIG. 3 illustrates the latter case, where three distinct physical objects 104(1), 104(2), 104(3) are represented holographically by three different frame sets, and the corresponding frame set is displayed when the viewer 102 is at a given vantage point. In particular, when the viewer 102 is at the first vantage point VP1, the image frame set for the first physical object 104(1) is displayed on the display device 112 of the PDS 100; when the viewer 102 is at the second vantage point VP2, the image frame set for the second physical object 104(2) is displayed on the display device 112 of the PDS 100; and when the viewer 102 is at the third vantage point VP3, the image frame set for the third physical object 104(3) is displayed on the display device 112 of the PDS 100. In one example use case, the physical objects 104 may be ladies dresses, where the PDS 100 shows the viewer three different dresses (e.g., three different frame sets), such as the same dress in different colors, or the dress with various seasonal attachments (e.g., a hood for the fall season). Similarly, the different physical objects 104 may correspond to the dress with different accessories (e.g., a hat and a handbag). The viewer (e.g., a potential buyer) may then see what the dress looks like in different contexts by simply changing where the viewer stands.

In some embodiments, the image frame sets may be encrypted, and the PDS 100 may decrypt each image frame set only when the viewer 102 is at the corresponding vantage point. For example, with reference to FIG. 2, when the viewer 102 is at the first vantage point VP1, the first image frame set FS1 is decrypted and displayed on the display device 112 of the PDS 100; when the viewer 102 is at the second vantage point VP2, the second image frame set FS2 is decrypted and displayed on the display device 112 of the PDS 100; and when the viewer 102 is at the third vantage point VP3, the third image frame set FS3 is decrypted and displayed on the display device 112 of the PDS 100.

Depending on the vantage point of the viewer 102, in some embodiments the image frame sets may be layered in their presentation, such that one image frame may partially hide another, thereby creating the effect of a 3-D topology that mimics the 3-D surface of the physical object. For example, the image frame set may represent a digitized surface of an oil painting, including all the undulations of the paint across the surface of the canvas. In this example, the surface topology on the canvas may be no more than 0.1mm in height, but ten images in the frame set may represent a micro-level scan (e.g., a CT scan) at 0.01mm, where the scan penetrates the paint in 0.01mm increments to produce ten sections or slices of the paint. When displayed, the 10 images reproduce the 0.1mm thick paint on the surface of the canvas. For digitized images of physical artworks, such as a painting on a canvas, the layered image sets may include digitized images of the surrounding frame of the painting, thereby enhancing the lifelike appearance of the digitized artwork to the viewer 102.

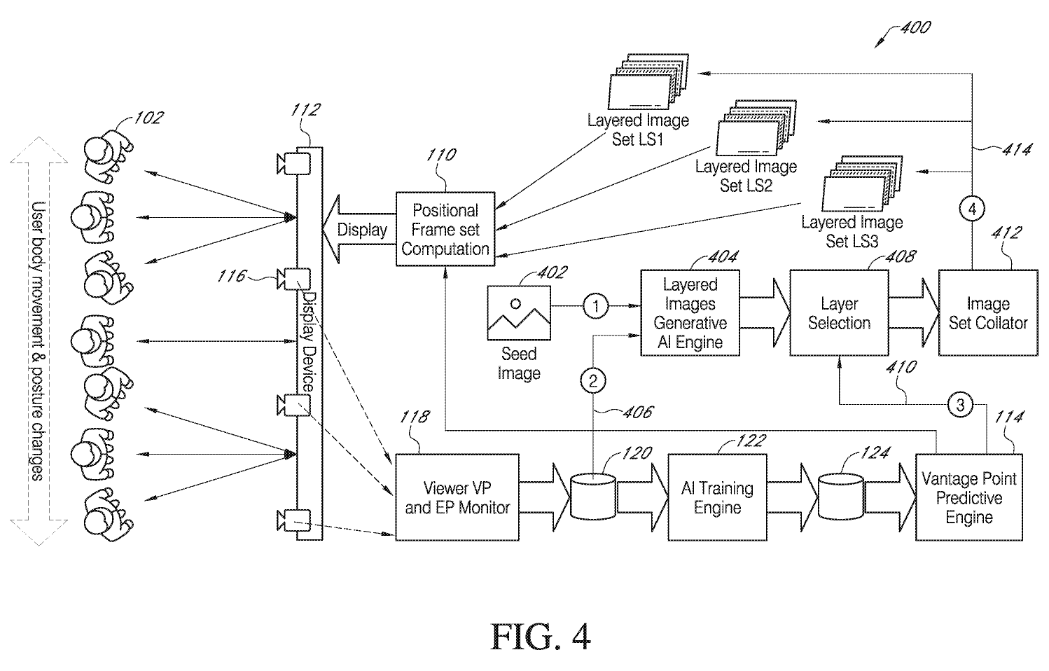

In some embodiments, the PDS may be configured to automatically compose a digital artwork (e.g., 2-D or 3-D) collated in a just-in-time fashion based on the viewer’s vantage point history, and which is personalized for the specific viewer. For example, as shown in FIG. 4, the PDS 400 can be extended to create sets of layered digital images LS1, LS2, LS3 that are automatically generated by the PDS 400 based on a seed image 402 that is provided as input to the positional frame set computation component 110 together with other input parameters, including the viewer’s vantage point history, the predicted next vantage point(s) of the viewer 102, and/or other parameters, and the sets of layered digital images LS1, LS2, LS3 can be viewed only from designated vantage points in front of the PDS 400. While three layered sets of digital images LS1, LS2, LS3 are shown in FIG. 4, any number of layered sets of digital images LS1, LS2, LS3, … LSN may be provided in various embodiments.

With reference to FIG. 4, in an example process for the automatic generation of layered digital image sets LS1, LS2, LS3, … LSN, the seed image 402 is input, at circle (1), to a layered images generative AI engine 404 that generates as output layers of images. Generative AI is a type of artificial intelligence technology that can generate various types of content, including text, imagery, audio, and synthetic data. Generative AI typically starts with a prompt that could be in the form of text, an image, a video, a design, musical notes, or any input that the AI system can process. Various AI algorithms then return new content in response to the prompt. Content can include essays, solutions to problems, or realistic fakes created from pictures or audio of a person. Generative AI models combine various AI algorithms to represent and process content. For example, to generate text, natural language processing techniques transform raw characters (e.g., letters, punctuation, and words) into sentences, parts of speech, entities, and actions, which are represented as vectors using multiple encoding techniques. Similarly, images are transformed into various visual elements, also expressed as vectors. Neural networks generate new content in response to a query or prompt. Techniques such as generative adversarial networks (GANs) and variational autoencoders (VAEs) -- neural networks with a decoder and encoder -- are used for generating realistic human faces, synthetic data for AI training, or even facsimiles of particular humans.

With continued reference to FIG. 4, the generative AI engine 404 also takes as input 406, at circle (2), the viewer’s accumulated history of vantage points stored in the viewer data store 120. Layer selection logic 408 then receives as input the layers of images and distributes the layers into different sets based on an input 410, at circle (3), from the VPPE 114 of the viewer’s predicted vantage points for a current session. An image set collator 412 then merges the layers into the layered image sets LS1, LS2, LS3, which are then provided as input 414, at circle (4), to the positional frame set computation component 110, which makes the layered image sets LS1, LS2, LS3 ready for display on the PDS 100. In some embodiments, some layers may be programmed to be nulled (e.g., made transparent) by the PDS 100 according to conditional parameters (e.g., a random value, a time of day, etc.). This aspect allows the creator of the seed image 402 (e.g., an artist) to create personalized images for the viewer 102.

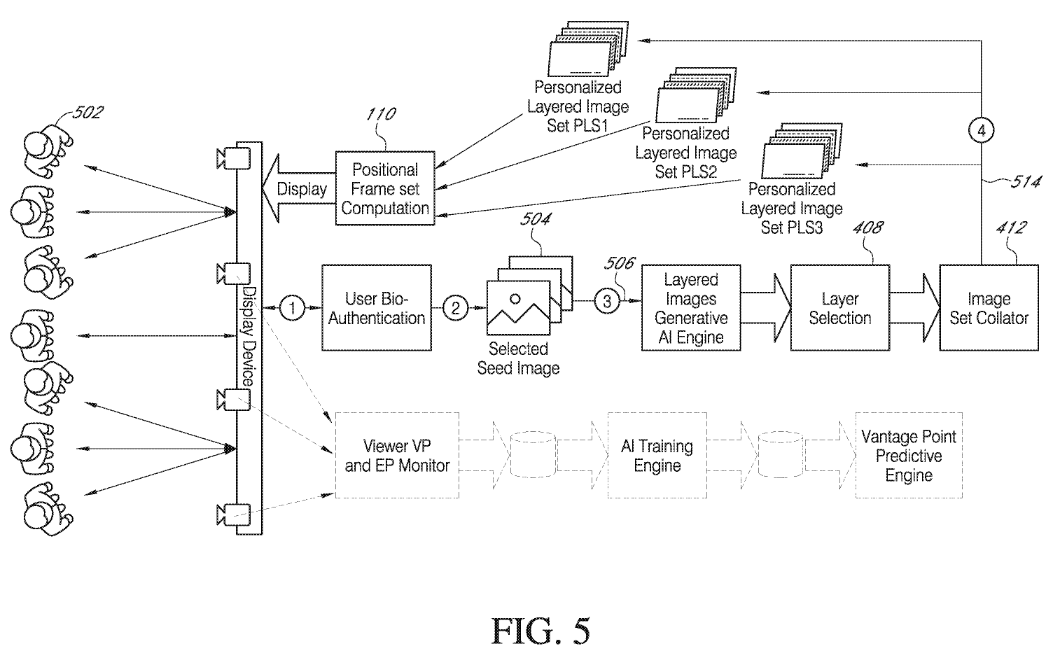

In some embodiments, personalized digital artwork may be created for different viewers based on the selection of a seed image specifically for the viewer, such that each viewer sees different personalized layered image sets (PLS1, PLS2, PLS3, … PLSN), as illustrated in FIG. 5. In the illustrated process, the viewer 502 is bio-authenticated, at circle (1), which establishes the viewer’s identity. A seed image 504 is then selected from the predictive models database 124, at circle (2), based on the viewer’s identity, and the selected seed image 504 is provided as input 506, at circle (3), into the generative AI engine 404, which outputs the image layers. Layer selection 408 and final image set collation then proceed as described above with respect to FIG. 4, and the output 514 from the final image set collator 412, at circle (4), is different sets of personalized layered image sets PLS1, PLS2, PLS3, which are then input to the positional frame set computation component 110, as described above. In some embodiments, an additional input to the process for selecting the seed image 504 includes data of the viewer’s vantage point history. A feedback-loop may also be used in which the observed vantage point(s) of the viewer 402 are input into the next cycle of seed image 504 selection.

In some embodiments, the PDS 100 can be used in metaverse interactions between/among users in different geographic locations. A metaverse is a collective virtual shared space, created by the convergence of virtually enhanced physical and digital reality. In some examples, a metaverse can include a networked and computer-implemented virtualized community that permits users to interact with one another using digital avatars or other graphical representations (within the confines of the virtualized computing systems or network). For example, metaverses can include any type of virtual shared space, such as social networking environments, gaming environments, educational environments, augmented reality (AR) environments, or any other virtual world involving user interaction. A metaverse can further include various types of metaverse assets. A metaverse asset, for example, can include non-fungible digital assets that are available for ownership and trading within a metaverse. A metaverse asset can include a combination of: (i) unique bytes of data representing the asset (e.g., an image file or other collection of data that can be rendered by a computing device to generate an image for human visual recognition on a display screen), (ii) issuance/creation of the asset by an entity (e.g., a person or an organization), and (iii) an association with one or more specific, networked, virtualized computing environments (e.g., a specific metaverse(s)), which together define a metaverse asset.

In some examples, a metaverse avatar is a graphical representation of a person, object, or venue within a metaverse. A metaverse can be associated with a network identifier representing a globally unique identifier for a given metaverse. A metaverse can be operated by a metaverse network 606 owner or operator, which may be a legal entity that owns and/or operates a networked virtualized computing environment implementing metaverse capabilities.

In some examples, a user avatar is a graphical digital representation of a human user employed within a metaverse. A user avatar controller is a person or entity controlling a user avatar within a metaverse. In some examples, an object avatar is a graphical digital representation of physical objects employed within a metaverse. For example, an object avatar can include a clothing item (e.g., a shirt, a hat, shoes, and the like), an accessory displayed in connection with a user avatar (e.g., a bag, jewelry, eyewear, and the like), a usable object (e.g., a weapon, a shield, gaming rewards, and the like), or any other objects relevant in various types of metaverses. An object avatar controller is a person or entity controlling an object avatar within a metaverse.

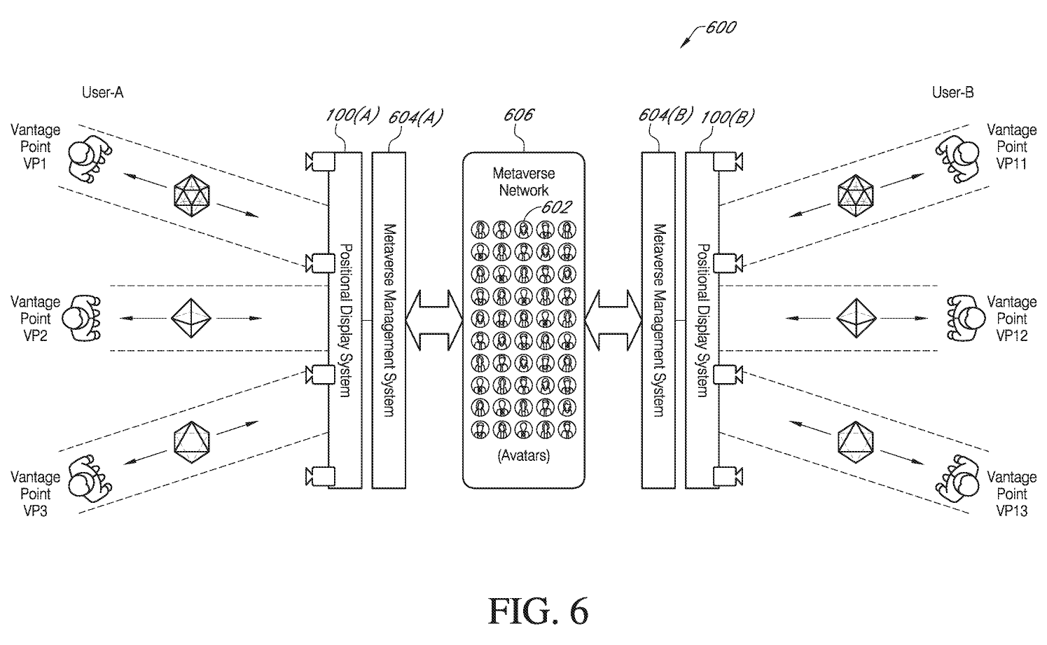

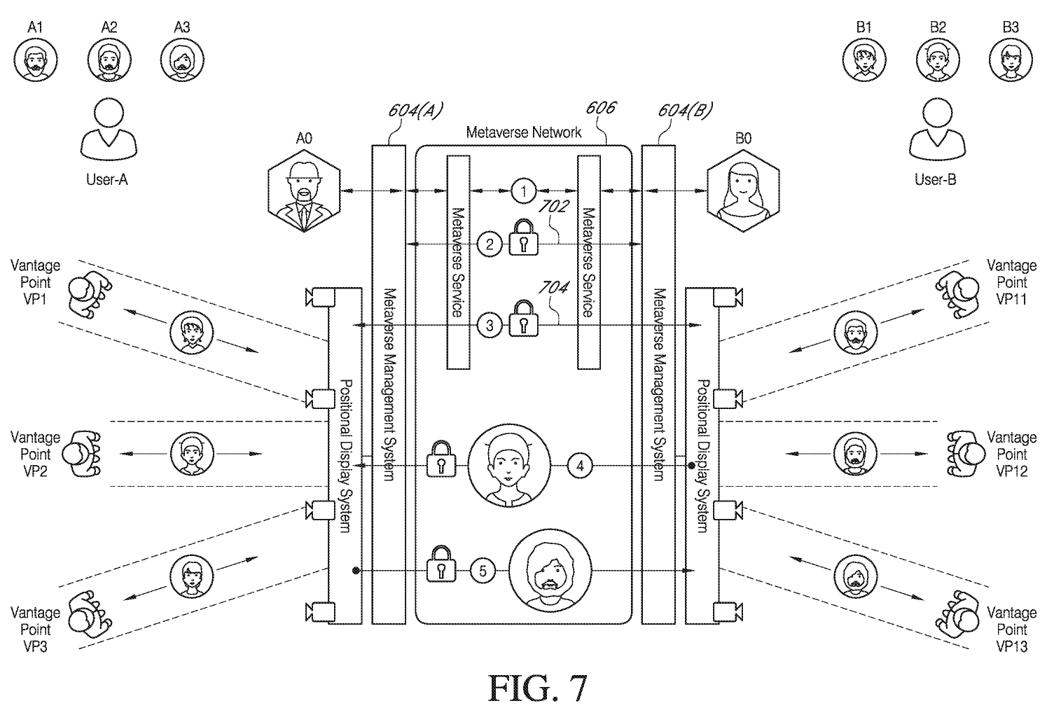

For example, FIG. 6 illustrates use of the PDS 100 in a metaverse network environment 600 where users are graphically represented as avatars 602, which can be 2-D, 3-D, or holograms, for example. Two users, User-A and User-B, each employ a metaverse management system (MMS) 604 to manage a secure connection and general interfacing with the metaverse network 606. Once a secure and authenticated channel has been established, the users can interact with one another via their avatars. In some embodiments, for each metaverse session between User-A and User-B their respective PDSs 100 may prepare multiple avatar images that are displayed to the other user based on the vantage point of that user. For example, as shown in FIG. 7, the PDS 100(A) of User-A prepares (e.g., precomputes) avatars A1, A2, A3 that are displayed on User-B’s PDS 100(B) based on the viewer’s (User-B’s) vantage points VP11, VP12, VP13, respectively. Similarly, the PDS 100(B) of User-B prepares (e.g., precomputes) avatars B1, B2, B3 that are displayed on User-A’s PDS 100(A) based on the viewer’s (User-A’s) vantage points VP1, VP2, VP3, respectively. While three avatars and three corresponding vantage points are shown for each user in FIG. 7, any number of avatars and/or corresponding vantage points may be provided in various embodiments.

In some embodiments, the metaverse network 606 may be operated by a third party (referred to as the metaverse service provider (MSP)), and the users of the PDS 100 may choose two classes of avatars, namely public avatars or private avatars. The public avatar may be used when connecting to the metaverse network 606, where other users with their avatars may be present. These other users may see the public avatars of User-A and User-B, which are shown as avatar A0 and B0 in FIG. 7. However, when User-A and User-B wish to use their respective PDSs 100 to interact privately, they may share private avatars between them. These private avatars are shown in FIG. 7 as avatars A1, A2, A3 for User-A, and avatars B1, B2, B3 for User-B. While three private avatars are shown for each user in FIG. 7, any number of private avatars may be provided in various embodiments.

In some embodiments, a user’s private avatars may be static (e.g., from a library of the user’s avatars) such that they don’t change from one session to another within the metaverse. Alternatively, a user’s private avatars may be algorithmically generated such that they do change from one session to another within the metaverse. In the latter case, the PDS 100 may generate the private avatars during a metaverse session, as described below. In some embodiments, the private avatar displayed by the PDS 100 may be dependent on the vantage point of another user as the viewer 102. Thus, for example, in FIG. 7 User-A’s first private avatar A1 is visible to User-B when User-B is at the first vantage point VP11, User-A’s second private avatar A2 is visible to User-B when User-B is at the second vantage point VP12, and User-A’s third private avatar A3 is visible to User-B when User-B is at the third vantage point VP13. Similarly, User-B’s first private avatar B1 is visible to User-A when User-A is at the first vantage point VP1, User-B’s second private avatar B2 is visible to User-A when User-A is at the second vantage point VP2, and User-B’s third private avatar B3 is visible to User-A when User-A is at the third vantage point VP3.

FIG. 7 illustrates an example interaction between the two users User-A, User-B in the metaverse network 606. At circle (1), the MMSs 604 of the respective users User-A, User-B discover and authenticate each other, using the credentials of the users. At this step, User-A and User-B may begin the interaction using their respective public avatars, which may be visible to other users in the metaverse network 606. These avatars are shown as avatar A0 for User-A and avatar B0 for User-B.

At circle (2) in FIG. 7, the respective MMSs 604 of User-A and User-B establish a secure (e.g., encrypted) channel, which is referred to herein as a session outer secure channel (OSC) 702. This encrypted session allows both User-A and User-B to interact in the metaverse network 606 in a private fashion independently of each user’s PDS 100. In some embodiments, while the session OSC 702 is established, the public avatars A0 and B0 of User-A and User-B may remain visible to other users in the metaverse network 606.

At circle (3) in FIG. 7, once the session OSC 702 has been established between the two MMSs 604, the PDSs 100 associated with the respective MMSs 604 perform device authentication of respective PDS hardware, and bio-authentication of the human users User-A, User-B (using the bio-authentication processes described above). The respective PDSs 100 then establish a secure (e.g., encrypted) channel, which is referred to herein as a session inner secure channel (ISC) 704, and which is separate from the session OSC 702 between the MMSs 604. In some embodiments, the session ISC 704 is tunneled (e.g., separately encrypted) within the session OSC 702.

At circles (4) and (5) in FIG. 7, after the session ISC 704 has been established between the PDSs 100, the respective PDSs 100 begin displaying the private avatars of User-A and User-B. The private avatars may be 2-D images, 3-D images, or hologram images in various embodiments. In some embodiments, the vantage point of User-A determines which private avatar of User-B will be displayed on User-A’s PDS 100(A), and the vantage point of User-B determines which private avatar of User-A will be displayed on User-B’s PDS 100(B). In the interaction illustrated in FIG. 7, User-A sees User-B’s second private avatar B2 when User-A is at the second vantage point VP2, and User-B sees User-A’s third private avatar A3 when User-B is at the third vantage point VP13, for example.

Similar to the image-generative process described above with reference to FIGS. 4 and 5, the private avatars described with reference to FIG. 7 may be, in some embodiments, algorithmically generated for each session with the metaverse (e.g., each time the user connects to the metaverse network 606). In such embodiments, the avatar-generation algorithm may take as input the following parameters: A seed avatar image selected for the session, a history of the user’s vantage points, a history (e.g., a library) of the user’s previous avatars, the avatars received from (displayed by) other users in the metaverse, session-specific parameters (e.g., metaverse ID, secure-channel session ID, etc.), the date and time of the metaverse session interaction, and the metabolic state of the user’s physical body (e.g., sugar/glucose level throughout the day). For example, if the user wears a smart watch or medical device that captures metabolic data from the user’s body (e.g., blood glucose level), the user’s avatar image could indicate that metabolic data (e.g., the user’s avatar image could glow red if the user’s blood glucose level is high, or glow blue if the user’s blood glucose level is low, or glow green if the user’s blood glucose level is normal).

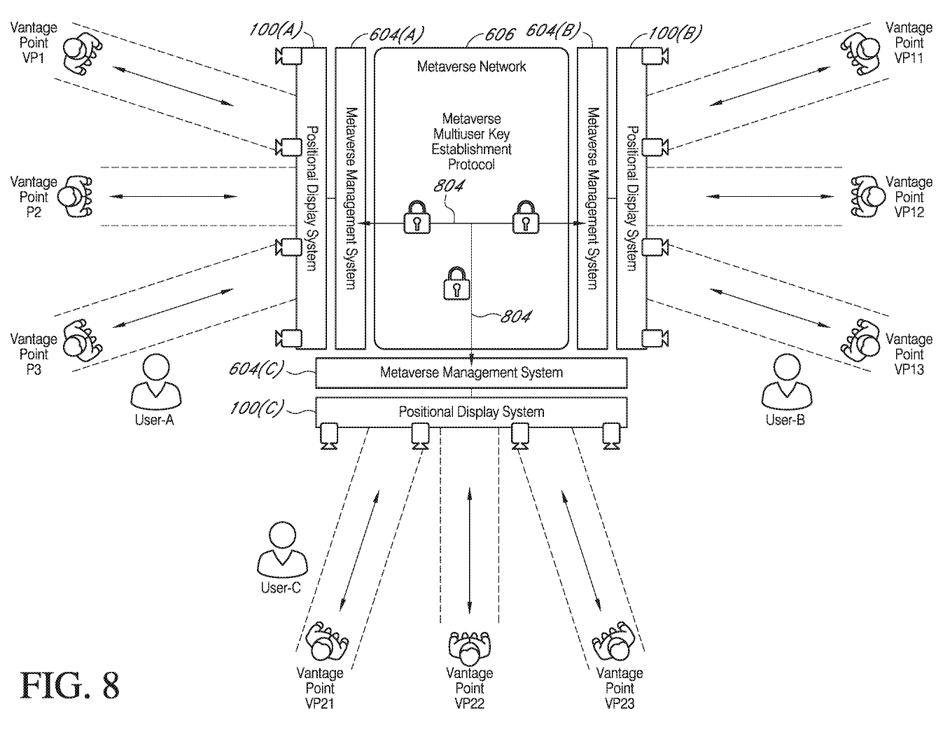

FIG. 8 illustrates use of the PDS 100 in a multi-user scenario in which more than two users interact via their public and/or private avatars in the metaverse network 606. In some embodiments, this multi-user scenario may use a session group key computed by all participants of the group. Similar to the previous case of two users (FIG. 7), here a session group inner secure channel (GISC) 804 may be established among all the PDSs 100 of the participating users. The key-establishment protocol may be referred to as a metaverse multi-user key establishment protocol, and may proceed similarly to the process described above with reference to circles (1)-(5) of FIG. 7, but with more than two MMSs 604 and PDSs 100 participating.

One aspect of typical metaverse networks is that a third party, namely the metaverse service provider (MSP), operates the metaverse network, which is disadvantageous from a privacy perspective. The MSP creates a computer-generated, digital, virtual environment to which remote users connect to interact graphically with other users via their remote-controlled avatars. However, this generally means that the MSP is able to monitor all interactions among all users connected to the metaverse network, which means the users have no privacy. One advantage of the session ISC 704 and the session GISC 804 described above with reference to FIGS. 7 and 8 is that it counters this privacy problem. Even with this approach, however, the MSP may still be able to detect that an interaction (e.g., a conversation) is occurring between two or more users in the metaverse, even though the MSP may not be able to decrypt the contents of the interaction. In the case where the interaction includes a trade of digital assets between User-A and User-B, this means that the fact of the transaction, and the negotiations prior to it, are not confidential.

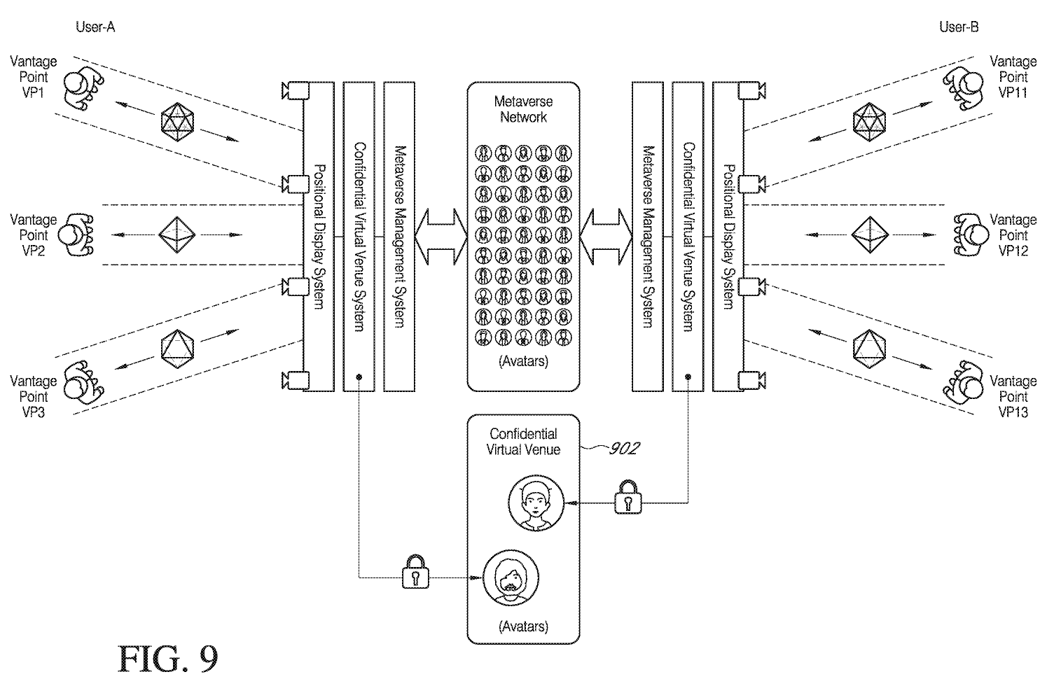

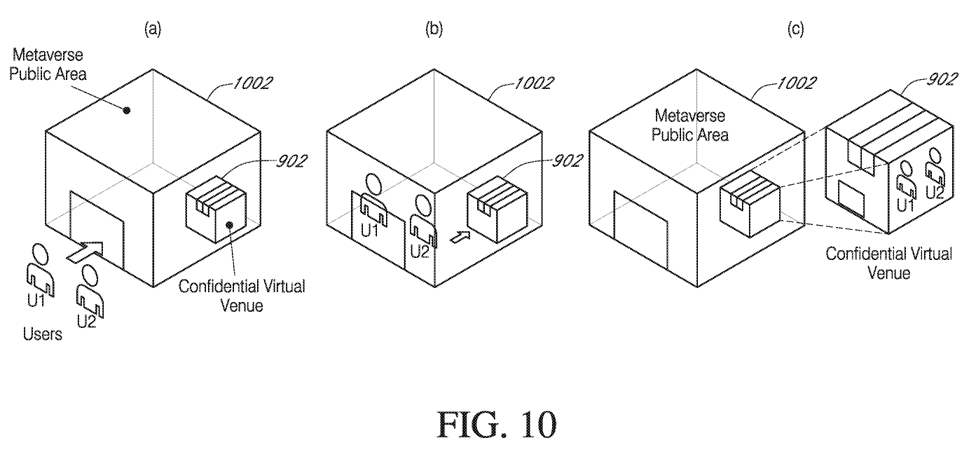

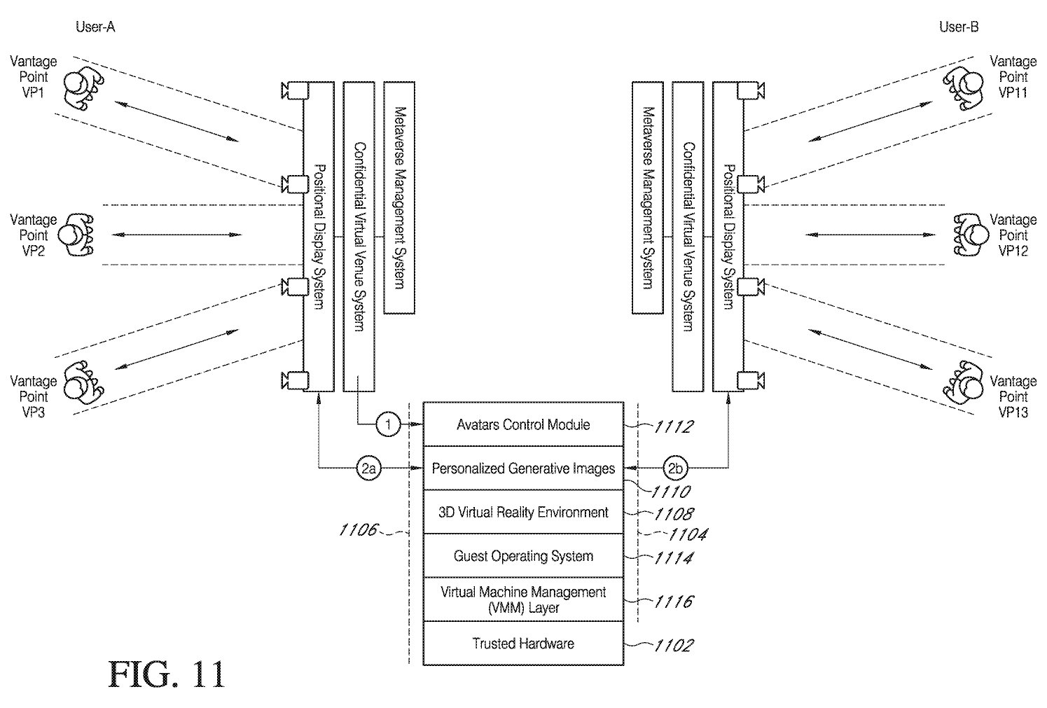

Some of the present embodiments solve this problem by establishing confidential virtual venues (CVVs) based on a trusted and secure hardware-based computing environment that can be securely segmented away from the main metaverse public network. With reference to FIG. 9, in the illustrated embodiment the CVV 902 includes its own 3-D graphical virtual reality world, where the software, images, and parameters execute confidentially (e.g., encrypted) entirely within the trusted and secure hardware-based computing environment. This is further illustrated in FIG. 10, where two users (User-A and User-B with avatars U1 and U2, respectively) interact within the metaverse public area 1002, as shown in FIG. 10(a) and FIG. 10(b). When the users seek a confidential venue separate from the metaverse public area 1002 where they can interact privately, they are able to break off from the metaverse public area 1002 and enter the CVV 902, as shown in FIG. 10(c). In some embodiments, the computing stack (hardware and software) used by the CVV 902 is distinct from the computing stack used by the metaverse public area 1002. For example, as shown in FIG. 11, all software executing above the guest operating system may be encrypted via the underlying trusted hardware 1102, with access keys (e.g., cryptographic keys) only available to the designated participants (e.g., User-A and User-B). One of the participating users (e.g., User-A) loads and boots up the stack 1104 on the selected CVV node 1106, as shown in FIG. 11, and later invites the other user(s) (e.g., User-B) once the complete stack 1104 is operational.

In some embodiments, the computing stack 1104 includes a 3-D virtual reality environment (e.g., a 3-D virtual room) 1108, which includes graphical images, coordinates, and/or parameters needed to project the 3-D virtual room 1108 to the PDSs 100 of User-A and User-B (with avatars U1 and U2, respectively). The computing stack 1104 further includes personalized generative images 1110, which is software (and/or firmware) that generates personalized images, as explained above with reference to FIGS. 4 and 5. This aspect allows both User-A and User-B to use their own PDSs 100 to generate their avatars for the current session, as described above. The computing stack 1104 further includes an avatars control module 1112, which is software (and/or firmware) that projects the selected avatar images within the 3-D virtual room 1108, allowing the users to control the movements of their respective avatars. The computing stack 1104 further includes a guest operating system 1114, and a virtual machine management layer 1116, which are software stack components that can be obtained from a third party (e.g., Azure, AWS (Amazon Web Services), etc.). An advantageous feature of the computing stack 1104, in some embodiments, is that the cryptographic hash of the entire stack 1104 is signed by one party (e.g., User-A) and validated by the other party (e.g., User-B) prior to loading and launching the stack 1104. This aspect helps to prevent one (or both) parties from cheating with regard to the authenticity of the software and/or firmware components in the stack 1104.

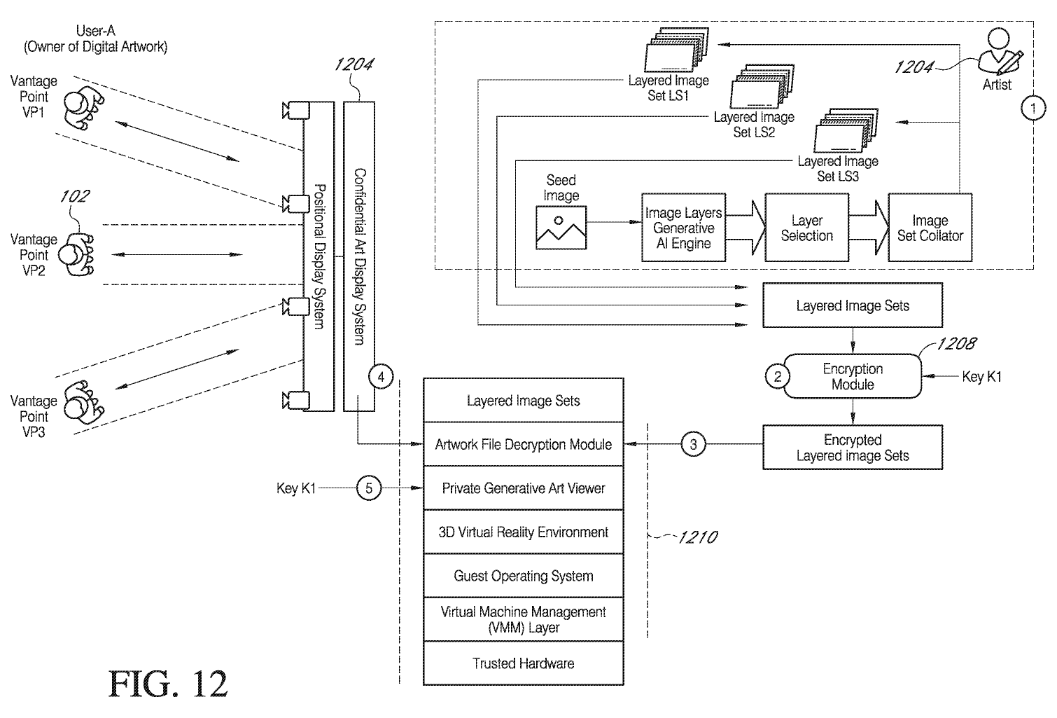

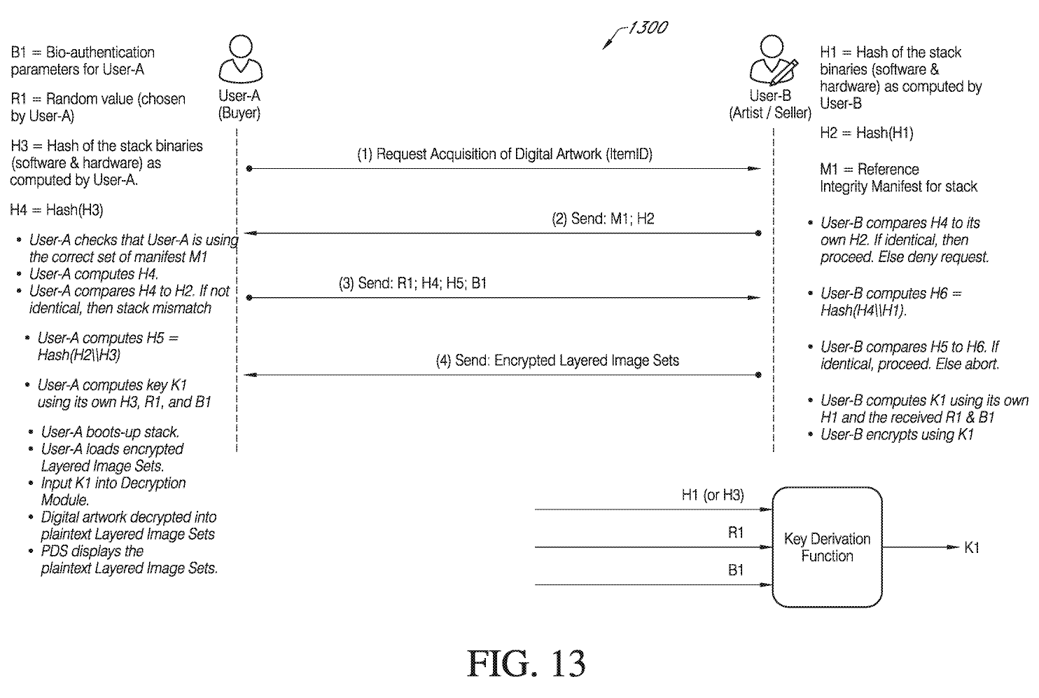

In some embodiments, the CVV stack 1104 may be extended to enable digital artwork to be designed and encrypted in such a way that it can be accessible and viewed only by the current (legal) owner and only with the correct software/hardware stack. For example, FIG. 12 illustrates a confidential art display system (CADS) 1204 that may use the features of the PDS 100 and the CVV 902 to enable an artist to prepare art images into frame sets and encrypt them in such a way that they can only be decrypted and viewed if User-A (e.g., the buyer or owner) is able to derive a key K1 and User-A has been bio-authenticated. At circle (1), the artist 1206 uses the method described above with reference to FIGS. 4 and 5 to generate layered image sets LS1, LS2, LS3, … LSN. At circle (2), an encryption module 1208 encrypts the layered image sets to the configuration of the stack 1210 using the key K1 in such a way that they will be decipherable only if the viewer 102 (User-A) is using the identical stack (e.g., identical binary files). At circle (3), the encrypted layered image sets are delivered to User-A along with a reference integrity manifest (RIM, described below) for every software/component that is required to decrypt and view the layered image sets. At circle (4), User-A boots up the CADS 1204 according to the technical specification associated with the artwork. Alternatively, User-A can download the complete binary stack from the artist’s site. At circle (5), the CADS 1204 of User-A computes the decryption key K1 and uses it to decrypt the layered image sets obtained at circle (3). The method to derive the key K1 on both sides is summarized in FIG. 13.

Reference Integrity Manifest (RIM) structures are used by a Verifier to validate expected values (Assertions) against actual values (Evidence). The RIM information model defines an abstract structure for assembling reference measurements (Assertions) that manufacturers and other supply chain entities assert as expected values. A RIM information model has several characteristics. For example, it identifies the creator (issuer) of the RIM instance; identifies the supply chain entity that produces reference values; contains reference measurements for installable software and/or firmware; contains reference measurements for embedded firmware; identifies the component, device, or environment; contains its own integrity protection capability (e.g., digital signature verification); and places constraints on RIM binding specifications that help ensure semantic interoperability and promote good security practice. RIM binding specifications define a realization of RIM information model expressions. RIM binding specifications define formats, protocols, storage, and delivery methods used to instantiate and convey reference information to a Verifier. RIM binding may instantiate, store, and retrieve RIM data on an Attester’s platform.

With reference to FIG. 13, User-A represents an acquirer (e.g., a buyer) in a transaction 1300 to acquire a digital artwork, and User-B represents an artist who is providing (e.g., selling) the digital artwork. In some embodiments, User-B may be a representative of or intermediary for the artist, rather than the artist, and in some embodiments User-B may be an owner of the digital artwork rather than the artist. Both User-A and User-B interact with respective computing devices (not shown), which may be, for example, desktop/laptop computers, smartphones, etc. User-A, and User-A’s computing device, have the following parameters: B1, which represents bio-authentication parameters for User-A; R1, which is a random value selected at User-A’s side; H3, which is a hash of the binaries in User-A’s stack (software and hardware), and H4, which is a hash of H3. User-B, and User-B’s computing device, have the following parameters: H1, which is a hash of the binaries in User-B’s stack (software and hardware); H2, which is a hash of H1; and M1, which is a reference integrity manifest (RIM) for User-B’s stack (software and firmware). While FIG. 13 indicates that User-A and User-B perform certain actions (e.g., User-A computes H4), in some cases these actions may be performed by User-A’s and User-B’s respective computing devices. In some embodiments, User-B may not be present, and the actions attributed to User-B herein may be performed entirely by one or more computing devices.

In some embodiments, the process 1300 of FIG. 13 ensures that both User-A and User-B are using identical computing stacks (e.g., the same set of binary files). This aspect helps to prevent one (or both) parties from cheating with regard to the authenticity of the software and/or firmware components in the stack. In some embodiments, the binary files include the complete bottom code (e.g., low-level BIOS code and/or other firmware for the target hardware) to middle code (e.g. operating systems) and applications. This could mean keeping a hash of thousands of software components. These are typically arranged in a hierarchy (e.g., a tree), where the hash values also mirror the hierarchy of the software components. An example data structure to keep the tree of hashes is called a Merkle Tree in which two hash-trees are identical if the roots of the trees have the same value. In some embodiments, as described below, the integrity of the process is secured by requiring both User-A and User-B to exchange the roots of their respective trees (or to exchange hashes of the roots of their respective trees).

The process of FIG. 13 begins at (1), where a request to acquire (e.g., purchase) a digital artwork is sent from User-A’s computing device to User-B’s computing device. The request may include an Item ID that identifies the digital artwork that User-A seeks to acquire. User-B’s computing device receives the request from User-A’s computing device and, in response, sends M1 (RIM for User-B’s stack) and H2 (hash of H1) to User-A’s computing device at (2). User-A’s computing device receives M1 and H2 from User-B’s computing device and checks that User-A is using the correct set of manifest M1. For example, the manifest M1 may be considered correct if it has all the correct software and firmware components (unmodified) that are needed to decrypt the layered image sets that were encrypted by the encryption module 1208 (FIG. 12). User-A’s computing device also computes H4, which is a hash of H3. User-A’s computing device then compares H4 to H2 and, if the two are not identical, then User-A’s stack is not identical to User-B’s stack, and the process terminates. In some embodiments, a message may be provided telling the user that the process terminated because there is something wrong in the user’s stack and a remediation process is needed. However, if H4 and H2 are identical, then User-A’s computing device computes H5, which is a hash of H2\\H3. User-A’s computing device then sends R1 (random value), H4 (hash of H3), H5 (hash of H2\\H3), and B1 (User-A’s bio-authentication parameters) to User-B’s computing device at (3). User-B’s computing device receives R1, H4, H5, and B1 from User-A’s computing device and determines whether H4 is identical to H2. If H4 is not identical to H2, then the process terminates (User-A’s request to acquire the digital artwork is denied). But, if H4 is identical to H2, then User-B’s computing device computes H6, which is a hash of H4\\H1. User-B’s computing device then determines whether H5 is identical to H6. If H5 is not identical to H6, then the process terminates (User-A’s request to acquire the digital artwork is denied). But, if H5 is identical to H6, then User-B’s computing device computes K1 according to a key derivation function using its own H1, as well as R1 and B1 received from User-A’s computing device. User-B’s computing device then encrypts the digital artwork using K1 as layered image sets, and sends the encrypted layered image sets to User-A’s computing device at (4). User-A’s computing device also computes K1 according to the key derivation function, but using its own H3, as well as R1 and B1. User-A’s computing device receives the encrypted layered image sets from User-B’s computing device, boots-up its stack, and loads the encrypted layered image sets. User-A’s computing device then inputs K1 into a decryption module, the encrypted layered image sets are decrypted into plaintext layered image sets, and User-A’s PDS 100 displays the plaintext layered image sets. In various embodiments, the key derivation function may be a cryptographic algorithm that derives K1 (a secret key) from a secret value, such as a master key, using a pseudorandom function, which may in turn use a cryptographic hash function or block cipher.

In various embodiments, H5 and H6 are used to discourage (e.g., detect) User-A and User-B cheating. For example, H6 computed by User-B cryptographically binds its own H1 with the H4 received from User-A (same with H5). Both User-A and User-B therefore cannot swap the hashes without being discovered. This method also prevents either of User-A or User-B from replaying the hash values to another unsuspecting User-C (e.g., User-B pretends to be User-A).

In the process 1300 described above and shown in FIG. 13, User-B’s computing device computes H2, which is a hash of H1, and sends H2 to User-A’s computing device. Similarly, User-A’s computing device computes H4, which is a hash of H3, and sends H4 to User-B’s computing device. These steps help to keep H1 and H3 secret, so as to prevent replay by the other party to the transaction. In alternative embodiments, User-A and User-B may exchange H1 and H3 with one another, such that H2 and H4 need not be computed, but the process would be less secure.

Some of the present embodiments provide a predictive display system (PDS) that enables the display of different image sets depending on the vantage point of the viewer. The image sets can range from slight variations of the image (e.g., a change in color or a change in viewing angle) to display of an image of a different object. The image sets may be pre-computed or computed on-the-fly based on vantage point data of the viewer in a current session and the viewer’s historical data from previous sessions. Predictive algorithms may be used to determine the viewer’s next likely vantage point(s) in the next milliseconds to seconds.

Some of the present embodiments provide a PDS that decrypts encrypted image sets depending on the vantage point of the viewer. The image sets may be encrypted either by the source (e.g., sender) of the image sets or by the PDS itself, and the image sets are decrypted only when the viewer has been bio-authenticated (e.g., using a retina scan) and the viewer has been vantage point-authenticated using vantage point historical data for the viewer.

Some of the present embodiments provide a method to create layers of digital images that are automatically generated based on a seed image. The seed image is provided as input together with other input parameters, including the history of the viewer’s vantage points, the predicted next vantage point(s) of the viewer, and other parameters. Different sets of layered images can be viewed only from the designated vantage points of the viewer in front of the display. Furthermore, some layers may be programmed to be nulled (e.g., made transparent) by the display according to other conditional parameters (e.g., random value, time of day, etc.).

Some of the present embodiments provide a method to create a personalized digital artwork for a specific authenticated viewer based on a history of the viewer’s vantage points and a selection of a seed image specifically for that viewer. In some embodiments, the viewer must be bio-authenticated (e.g., by a retina scan), and the seed image selection mechanism uses an algorithm that picks the seed image (from a pool of seed images) based on the viewer’s vantage point history, the predicted next vantage point(s) of the viewer, and other parameters. A feedback loop may also be used in which the observed vantage point(s) of the viewer are input into the next cycle of the seed image selection.

Some of the present embodiments provide a method to present a set of image frames in a layered arrangement, such that from the viewer’s vantage point one image frame partially hides another, creating the visual effect of a 3-D topology that mimics the surface of the object represented by the layered image frames. Depending on the vantage point(s) of the viewer, different overlays of the image frames in the set are displayed.

Some of the present embodiments provide a method to establish a private metaverse session between or among the PDS’s of two or more users. Each user initially employs a public avatar when connecting to the metaverse network, but once a secure channel has been established between their PDS’s, the users may employ a different private avatar that is visible only by the participants on the secure channel. What is displayed by the PDS of each user depends upon the vantage points of that particular user as the viewer.

Some of the present embodiments provide a method to algorithmically generate a unique avatar for each metaverse network session. The avatar-generation algorithm starts with an avatar seed image, which can be 2-D, 3-D, or holographic. The algorithm then computes a new avatar for each metaverse network session based on input parameters, including the viewer’s vantage point history, the avatars received (displayed) from other users, session-specific network parameters (e.g., a metaverse ID, a secure-channel session ID, etc.), the date and time of the metaverse session, etc.

Some of the present embodiments provide a method to establish a confidential virtual venue (CVV) as a break-off session from the metaverse, enabling users to still be present in the metaverse, but at the same time engage in confidential interactions (e.g., via voice, avatars, and/or images) in a separate trusted computer system that is distinct from the computer system of the metaverse. The trusted computer system provides confidentiality for the session via execution in a separate protected CPU, while the small 3-D virtual reality environment loaded atop the stack of the trusted computer system provides the CVV.

Some of the present embodiments provide a method to encrypt image files into image frame sets using a key that is derived from a combination of a hash of the software/firmware stack of a viewer’s computer system, bio-authentication parameters of the viewer, and a random value chosen by the viewer or the viewer’s computer system. For example, in some embodiments the viewer must use a computer system that has a software/firmware stack that is identical to the software/firmware stack of the computer system used to encrypt the image files. The decrypted plaintext images can only then be viewed by using a PDS that enables the display of different image sets depending on the vantage point of the viewer.

### Illustrative Systems

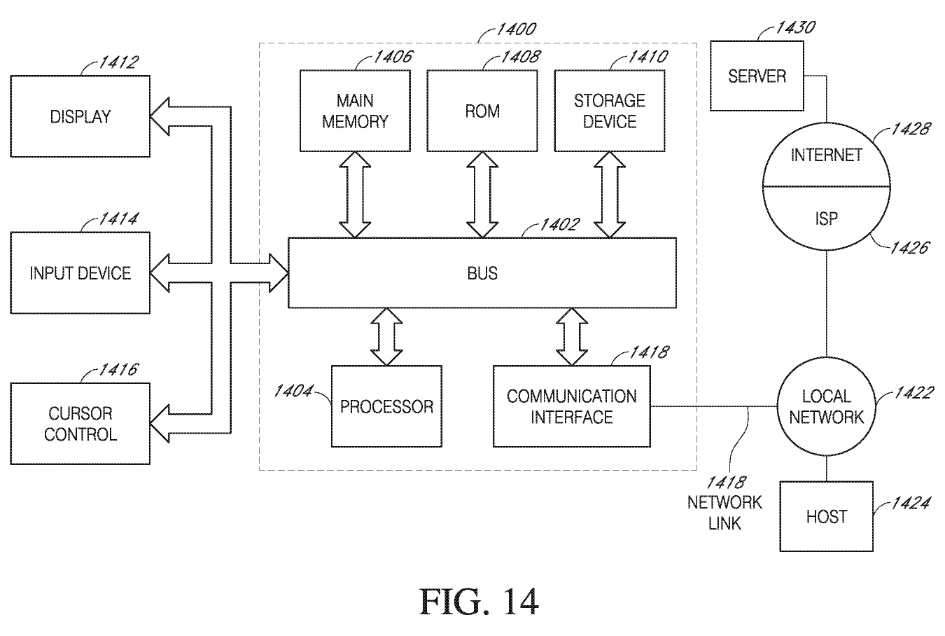

FIG. 14 is a block diagram that illustrates a computer system 1400 utilized in implementing the above-described techniques, according to an example. Computer system 1400 may be, for example, a desktop computing device, laptop computing device, tablet, smartphone, server appliance, computing mainframe, multimedia device, handheld device, networking apparatus, or any other suitable device.

Computer system 1400 includes one or more buses 1402 or other communication mechanism for communicating information, and one or more hardware processors 1404 coupled with buses 1402 for processing information. Hardware processors 1404 may be, for example, general purpose microprocessors. Buses 1402 may include various internal and/or external components, including, without limitation, internal processor or memory busses, a Serial ATA bus, a PCI Express bus, a Universal Serial Bus, a HyperTransport bus, an Infiniband bus, and/or any other suitable wired or wireless communication channel.

Computer system 1400 also includes a main memory 1406, such as a random-access memory (RAM) or other dynamic or volatile storage device, coupled to bus 1402 for storing information and instructions to be executed by processor 1404. Main memory 1406 also may be used for storing temporary variables or other intermediate information during execution of instructions to be executed by processor 1404. Such instructions, when stored in non-transitory storage media accessible to processor 1404, render computer system 1400 a special-purpose machine that is customized to perform the operations specified in the instructions.

Computer system 1400 further includes one or more read only memories (ROM) 1408 or other static storage devices coupled to bus 1402 for storing static information and instructions for processor 1404. One or more storage devices 1410, such as a solid-state drive (SSD), magnetic disk, optical disk, or other suitable non-volatile storage device, is provided and coupled to bus 1402 for storing information and instructions.

Computer system 1400 may be coupled via bus 1402 to one or more displays 1412 for presenting information to a computer user. For instance, computer system 1400 may be connected via a High-Definition Multimedia Interface (HDMI) cable or other suitable cabling to a Liquid Crystal Display (LCD) monitor, and/or via a wireless connection such as peer-to-peer Wi-Fi Direct connection to a Light-Emitting Diode (LED) television. Other examples of suitable types of displays 1412 may include, without limitation, plasma display devices, projectors, cathode ray tube (CRT) monitors, electronic paper, virtual reality headsets, braille terminal, and/or any other suitable device for outputting information to a computer user. In an example, any suitable type of output device, such as, for instance, an audio speaker or printer, may be utilized instead of a display 1412.

One or more input devices 1414 are coupled to bus 1402 for communicating information and command selections to processor 1404. One example of an input device 1414 is a keyboard, including alphanumeric and other keys. Another type of user input device 1414 is cursor control 1416, such as a mouse, a trackball, or cursor direction keys for communicating direction information and command selections to processor 1404 and for controlling cursor movement on display 1412. This input device typically has two degrees of freedom in two axes, a first axis (e.g., x) and a second axis (e.g., y), that allows the device to specify positions in a plane. Yet other examples of suitable input devices 1414 include a touch-screen panel affixed to a display 1412, cameras, microphones, accelerometers, motion detectors, and/or other sensors. In an example, a network-based input device 1414 may be utilized. In such an example, user input and/or other information or commands may be relayed via routers and/or switches on a Local Area Network (LAN) or other suitable shared network, or via a peer-to-peer network, from the input device 1414 to a network link 1420 on the computer system 1400.

A computer system 1400 may implement techniques described herein using customized hard-wired logic, one or more ASICs or FPGAs, firmware and/or program logic which in combination with the computer system causes or programs computer system 1400 to be a special-purpose machine. According to one example, the techniques herein are performed by computer system 1400 in response to processor 1404 executing one or more sequences of one or more instructions contained in main memory 1406. Such instructions may be read into main memory 1406 from another storage medium, such as storage device 1410. Execution of the sequences of instructions contained in main memory 1406 causes processor 1404 to perform the process steps described herein. In alternative examples, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 1410. Volatile media includes dynamic memory, such as main memory 1406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, an EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1402. Transmission media can also take the form of acoustic or light waves, such as those generated during radio-wave and infra-red data communications.

Various forms of media may be involved in carrying one or more sequences of one or more instructions to processor 1404 for execution. For example, the instructions may initially be carried on a magnetic disk or a solid-state drive of a remote computer. The remote computer can load the instructions into its dynamic memory and use a modem to send the instructions over a network, such as a cable network or cellular network, as modulate signals. A modem local to computer system 1400 can receive the data on the network and demodulate the signal to decode the transmitted instructions. Appropriate circuitry can then place the data on bus 1402. Bus 1402 carries the data to main memory 1406, from which processor 1404 retrieves and executes the instructions. The instructions received by main memory 1406 may optionally be stored on storage device 1410 either before or after execution by processor 1404.

A computer system 1400 may also include, in an example, one or more communication interfaces 1418 coupled to bus 1402. A communication interface 1418 provides a data communication coupling, typically two-way, to a network link 1420 that is connected to a local network 1422. For example, a communication interface 1418 may be an integrated services digital network (ISDN) card, cable modem, satellite modem, or a modem to provide a data communication connection to a corresponding type of telephone line. As another example, the one or more communication interfaces 1418 may include a local area network (LAN) card to provide a data communication connection to a compatible LAN. As yet another example, the one or more communication interfaces 1418 may include a wireless network interface controller, such as an 802.11-based controller, Bluetooth controller, Long Term Evolution (LTE) modem, and/or other types of wireless interfaces. In any such implementation, communication interface 1418 sends and receives electrical, electromagnetic, or optical signals that carry digital data streams representing various types of information.

Network link 1420 typically provides data communication through one or more networks to other data devices. For example, network link 1420 may provide a connection through local network 1422 to a host computer 1424 or to data equipment operated by a Service Provider 1426. Service Provider 1426, which may for example be an Internet Service Provider (ISP), in turn provides data communication services through a wide area network, such as the worldwide packet data communication network now commonly referred to as the “Internet” 1428. Local network 1422 and Internet 1428 both use electrical, electromagnetic, or optical signals that carry digital data streams. The signals through the various networks and the signals on network link 1420 and through communication interface 1418, which carry the digital data to and from computer system 1400, are example forms of transmission media.

In an example, computer system 1400 can send messages and receive data, including program code and/or other types of instructions, through the network(s), network link 1420, and communication interface 1418. In the Internet example, a server 1430 might transmit a requested code for an application program through Internet 1428, ISP 1426, local network 1422 and communication interface 1418. The received code may be executed by processor 1404 as it is received, and/or stored in storage device 1410, or other non-volatile storage for later execution. As another example, information received via a network link 1420 may be interpreted and/or processed by a software component of the computer system 1400, such as a web browser, application, or server, which in turn issues instructions based thereon to a processor 1404, possibly via an operating system and/or other intermediate layers of software components.

In an example, some or all of the systems described herein may be or comprise server computer systems, including one or more computer systems 1400 that collectively implement various components of the system as a set of server-side processes. The server computer systems may include web server, application server, database server, and/or other conventional server components that certain above-described components utilize to provide the described functionality. The server computer systems may receive network-based communications comprising input data from any of a variety of sources, including without limitation user-operated client computing devices such as desktop computers, tablets, or smartphones, remote sensing devices, and/or other server computer systems.

In an example, certain server components may be implemented in full or in part using “cloud”-based components that are coupled to the systems by one or more networks, such as the Internet. The cloud-based components may expose interfaces by which they provide processing, storage, software, and/or other resources to other components of the systems. In an example, the cloud-based components may be implemented by third-party entities, on behalf of another entity for whom the components are deployed. In other examples, however, the described systems may be implemented entirely by computer systems owned and operated by a single entity.

In an example, an apparatus comprises a processor and is configured to perform any of the foregoing methods. In an example, a non-transitory computer readable storage medium, storing software instructions, which when executed by one or more processors cause performance of any of the foregoing methods.

Various examples discussed or suggested herein can be implemented in a wide variety of operating environments, which in some cases can include one or more user computers, computing devices, or processing devices which can be used to operate any of a number of applications. User or client devices can include any of a number of general-purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems, and/or other devices capable of communicating via a network.

Most examples use at least one network that would be familiar to those skilled in the art for supporting communications using any of a variety of widely-available protocols, such as Transmission Control Protocol / Internet Protocol (TCP/IP), File Transfer Protocol (FTP), Universal Plug and Play (UPnP), Network File System (NFS), Common Internet File System (CIFS), Extensible Messaging and Presence Protocol (XMPP), AppleTalk, etc. The network(s) can include, for example, a local area network (LAN), a wide-area network (WAN), a virtual private network (VPN), the Internet, an intranet, an extranet, a public switched telephone network (PSTN), an infrared network, a wireless network, and any combination thereof.

In examples using a web server, the web server can run any of a variety of server or mid-tier applications, including HTTP servers, File Transfer Protocol (FTP) servers, Common Gateway Interface (CGI) servers, data servers, Java servers, business application servers, etc. The server(s) also can be capable of executing programs or scripts in response requests from user devices, such as by executing one or more Web applications that can be implemented as one or more scripts or programs written in any programming language, such as Java®, C, C# or C++, or any scripting language, such as Perl, Python, PHP, or TCL, as well as combinations thereof. The server(s) can also include database servers, including without limitation those commercially available from Oracle(R), Microsoft(R), Sybase(R), IBM(R), etc. The database servers can be relational or non-relational (e.g., “NoSQL”), distributed or non-distributed, etc.

Environments disclosed herein can include a variety of data stores and other memory and storage media as discussed above. These can reside in a variety of locations, such as on a storage medium local to (and/or resident in) one or more of the computers or remote from any or all of the computers across the network. In a particular set of examples, the information can reside in a storage-area network (SAN) familiar to those skilled in the art. Similarly, any necessary files for performing the functions attributed to the computers, servers, or other network devices can be stored locally and/or remotely, as appropriate. Where a system includes computerized devices, each such device can include hardware elements that can be electrically coupled via a bus, the elements including, for example, at least one central processing unit (CPU), at least one input device (e.g., a mouse, keyboard, controller, touch screen, or keypad), and/or at least one output device (e.g., a display device, printer, or speaker). Such a system can also include one or more storage devices, such as disk drives, optical storage devices, and solid-state storage devices such as random-access memory (RAM) or read-only memory (ROM), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or web browser. It should be appreciated that alternate examples can have numerous variations from that described above. For example, customized hardware might also be used and/or particular elements might be implemented in hardware, software (including portable software, such as applets), or both. Further, connection to other computing devices such as network input/output devices can be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, Electrically Erasable Programmable Read-Only Memory (EEPROM), flash memory or other memory technology, Compact Disc-Read Only Memory (CD-ROM), Digital Versatile Disk (DVD) or other optical storage, magnetic cassettes, magnetic tape, magnetic disk storage or other magnetic storage devices, or any other medium which can be used to store the desired information and which can be accessed by a system device. Based on the disclosure and teachings provided herein, a person of ordinary skill in the art will appreciate other ways and/or methods to implement the various examples.

In the preceding description, various examples are described. For purposes of explanation, specific configurations and details are set forth in order to provide a thorough understanding of the examples. However, it will also be apparent to one skilled in the art that the examples can be practiced without the specific details. Furthermore, well-known features can be omitted or simplified in order not to obscure the example being described.

Bracketed text and blocks with dashed borders (e.g., large dashes, small dashes, dot-dash, and dots) are used herein to illustrate optional aspects that add additional features to some examples. However, such notation should not be taken to mean that these are the only options or optional operations, and/or that blocks with solid borders are not optional in certain examples.

Reference numerals with suffix numbers (e.g., 104(1), 104(2), 104(3)) can be used to indicate that there can be one or multiple instances of the referenced entity in various examples, and when there are multiple instances, each does not need to be identical but may instead share some general traits or act in common ways. Further, the particular suffixes used are not meant to imply that a particular amount of the entity exists unless specifically indicated to the contrary. Thus, two entities using the same or different suffix letters might or might not have the same number of instances in various examples.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” is intended to be understood to mean either A, B, or C, or any combination thereof (e.g., A, B, and/or C). Similarly, language such as “at least one or more of A, B, and C” (or “one or more of A, B, and C”) is intended to be understood to mean A, B, or C, or any combination thereof (e.g., A, B, and/or C). As such, disjunctive language is not intended to, nor should it be understood to, imply that a given example requires at least one of A, at least one of B, and at least one of C to each be present.

As used herein, the term “based on” (or similar) is an open-ended term used to describe one or more factors that affect a determination or other action. It is to be understood that this term does not foreclose additional factors that may affect a determination or action. For example, a determination may be solely based on the factor(s) listed or based on the factor(s) and one or more additional factors. Thus, if an action A is “based on” B, it is to be understood that B is one factor that affects action A, but this does not foreclose the action from also being based on one or multiple other factors, such as factor C. However, in some instances, action A may be based entirely on B.

Unless otherwise explicitly stated, articles such as “a” or “an” should generally be interpreted to include one or multiple described items. Accordingly, phrases such as “a device configured to” or “a computing device” are intended to include one or multiple recited devices. Such one or more recited devices can be collectively configured to carry out the stated operations. For example, “a processor configured to carry out operations A, B, and C” can include a first processor configured to carry out operation A working in conjunction with a second processor configured to carry out operations B and C.

Further, the words “may” or “can” are used in a permissive sense (i.e., meaning having the potential to), rather than the mandatory sense (i.e., meaning must). The words “include,” “including,” and “includes” are used to indicate open-ended relationships and therefore mean including, but not limited to. Similarly, the words “have,” “having,” and “has” also indicate open-ended relationships, and thus mean having, but not limited to. The terms “first,” “second,” “third,” and so forth as used herein are used as labels for the nouns that they precede, and do not imply any type of ordering (e.g., spatial, temporal, logical, etc.) unless such an ordering is otherwise explicitly indicated. Similarly, the values of such numeric labels are generally not used to indicate a required amount of a particular noun in the claims recited herein, and thus a “fifth” element generally does not imply the existence of four other elements unless those elements are explicitly included in the claim or it is otherwise made abundantly clear that they exist.

The specification and drawings are, accordingly, to be regarded in an illustrative rather than a restrictive sense. It will, however, be evident that various modifications and changes can be made thereunto without departing from the broader scope of the disclosure as set forth in the claims.

What is claimed is:

1. A computer-implemented method performed by a predictive display system (PDS), the method comprising:
capturing, by a set of one or more cameras of the PDS, images of a physical object from different angles;
generating, by a holographic image generator of the PDS based on the images of the physical object, a 3-D image of the physical object;
computing, by a positional frame set computation component of the PDS based on the 3-D image of the physical object, sets of image frames, wherein each set of image frames represents the physical object from different vantage points;
determining, by a viewer vantage point and eye position monitor of the PDS, a vantage point of a viewer with respect to a display device of the PDS;
selecting a set of image frames from among the sets of image frames to be displayed on the display device of the PDS based on the vantage point of the viewer with respect to the display device; and
displaying the set of image frames on the display device of the PDS.

2. The computer-implemented method of claim 1, wherein selecting the set of image frames from among the sets of image frames to be displayed on the display device of the PDS based on the vantage point of the viewer with respect to the display device comprises:
selecting a first set of image frames from among the sets of image frames when it is determined that the viewer is at a first vantage point that is toward a left side of the display device;
selecting a second set of image frames from among the sets of image frames when it is determined that the viewer is at a second vantage point that is directly in front of a center of the display device; and
selecting a third set of image frames from among the sets of image frames when it is determined that the viewer is at a third vantage point that is toward a right side of the display device.

3. The computer-implemented method of claim 1, wherein the viewer vantage point and eye position monitor of the PDS includes sensors that track the vantage point of the viewer as the viewer moves about in front of the display device.

4. A computer-implemented method comprising:
computing sets of image frames, wherein each set of image frames represents a physical object from different vantage points;
determining a vantage point of a viewer with respect to a display device;
selecting a set of image frames from among the sets of image frames to be displayed on the display device based on the vantage point of the viewer with respect to the display device; and
displaying the set of image frames on the display device.

5. The computer-implemented method of claim 4, wherein selecting the set of image frames from among the sets of image frames to be displayed on the display device based on the vantage point of the viewer with respect to the display device comprises:
selecting a first set of image frames from among the sets of image frames when it is determined that the viewer is at a first vantage point that is toward a left side of the display device;
selecting a second set of image frames from among the sets of image frames when it is determined that the viewer is at a second vantage point that is directly in front of a center of the display device; and
selecting a third set of image frames from among the sets of image frames when it is determined that the viewer is at a third vantage point that is toward a right side of the display device.

6. The computer-implemented method of claim 4, wherein determining the vantage point of the viewer with respect to the display device is based on input from sensors that track the vantage point of the viewer as the viewer moves about in front of the display device.

7. The computer-implemented method of claim 6, wherein the sensors detect one or more of body position, body orientation, body posture, eye position, or eye orientation of the viewer.

8. The computer-implemented method of claim 4, wherein determining the vantage point of the viewer with respect to the display device is based on output of a vantage point predictive engine (VPPE) that uses a predictive model and parameters for the viewer to compute likelihoods for next possible vantage points of the viewer with respect to the display device.

9. The computer-implemented method of claim 8, wherein the output of the VPPE of one or more sets of possible vantage point parameters is provided as input to a positional frame set computation module, which uses the input to compute the sets of image frames.

10. The computer-implemented method of claim 4, further comprising authenticating the viewer based on physical features of the viewer.

11. The computer-implemented method of claim 10, wherein the physical features include one or more of a fingerprint, a palmprint, a facial feature, or a retinal pattern.

12. The computer-implemented method of claim 4, further comprising encrypting the sets of image frames and decrypting the set of image frames prior to displaying the set of image frames on the display device.

13. The computer-implemented method of claim 12, further comprising authenticating the viewer prior to decrypting the set of image frames.

14. The computer-implemented method of claim 4, wherein image frames of the image frame set are layered with respect to one another, such that one of the image frames partially hides another one of the image frames on the display device, thereby effecting a 3-D topology on the display device that mimics 3-D surface features of the physical object.

15. A computing system comprising:
one or more processors; and
memory storing instructions that, upon execution by the one or more processors, cause the computing system to:
compute sets of image frames, wherein each set of image frames represents a physical object from different vantage points;
determine a vantage point of a viewer with respect to a display device;
select a set of image frames from among the sets of image frames to be displayed on the display device based on the vantage point of the viewer with respect to the display device; and
display the set of image frames on the display device.

16. The computing system of claim 15, wherein to select the set of image frames from among the sets of image frames to be displayed on the display device based on the vantage point of the viewer with respect to the display device, the instructions comprise further instructions that, upon execution by the one or more processors, further cause the computing system to:
select a first set of image frames from among the sets of image frames when it is determined that the viewer is at a first vantage point that is toward a left side of the display device;
select a second set of image frames from among the sets of image frames when it is determined that the viewer is at a second vantage point that is directly in front of a center of the display device; and
select a third set of image frames from among the sets of image frames when it is determined that the viewer is at a third vantage point that is toward a right side of the display device.

17. The computing system of claim 15, wherein determining the vantage point of the viewer with respect to the display device is based on input from sensors configured to track the vantage point of the viewer as the viewer moves about in front of the display device.

18. The computing system of claim 17, wherein the sensors are configured to detect one or more of body position, body orientation, body posture, eye position, or eye orientation of the viewer.

19. The computing system of claim 15, wherein determining the vantage point of the viewer with respect to the display device is based on output of a vantage point predictive engine (VPPE) configured to use a predictive model and parameters for the viewer to compute likelihoods for next possible vantage points of the viewer with respect to the display device.

20. The computing system of claim 15, wherein the output of the VPPE of one or more sets of possible vantage point parameters is provided as input to a positional frame set computation module, which is configured to use the input to compute the sets of image frames.
